(19) United States
(12) Patent Application Publication
(10) Pub. No.: US 2019/0303363 A1
(43) Pub. Date: Oct. 3, 2019

(54) SYSTEM AND METHOD FOR OPERATING A BLOCKCHAIN NETWORK

(71) Applicant: AnApp Technologies Limited, Kowloon (HK)

(72) Inventors: Frederick Kwok Yin LEUNG, Mongkok (HK); Marcin Wojciech DUDAR, Ma Wan (HK); Peter On Bon CHAN, Shatin (HK)

(21) Appl. No.: 16/369,070

(22) Filed: Mar. 29, 2019

Related U.S. Application Data
(60) Provisional application No. 62/649,588, filed on Mar. 29, 2018.

(51) Int. Cl. G06F 16/23; G06F 16/2458; G06F 9/54

(52) U.S. Cl. CPC G06F 16/2379; G06F 2216/03; G06F 9/547; G06F 16/2465

(57) ABSTRACT

A system and method for operating a blockchain network including ledger servers arranged in a first mesh network and collectively maintaining a blockchain ledger. The method includes: determining that a new transaction data block is to be added to the blockchain ledger, and assigning a mining task: (i) to one or more and not all of the ledger servers; or (ii), via one or more of the ledger servers, to one or more electrical IoT devices operably connected with the respective one or more ledger servers. The mining task is to compute a HASH value associated with the new transaction for adding the new transaction data block to the blockchain ledger.

### TECHNICAL FIELD

The invention relates to operation of a blockchain network and related system and method.

### BACKGROUND

FIGS. 1A and 1B illustrate an example of a basic blockchain network 100. The blockchain network 100 includes multiple (five shown, for illustration), distributed information handling devices 100₁-100₅ (e.g. computers; also called “ledger servers” or “ledger server nodes”) operably connected with each other. In this example, the network 100 includes five ledger servers 100₁-100₅. As illustrated in FIG. 1B, the ledger servers 100₁-100₅ are connected to form a mesh network, i.e., each ledger server is directly and dynamically connected with each and every other ledger server in the network through a communication link (shown as arrows), which may be wired or wireless. Each of the ledger servers 100₁-100₅ in the network 100 maintains a respective, identical blockchain that has one or more transaction blocks containing past transaction information.

FIG. 2 illustrates an exemplary data structure of a blockchain 20 held by the ledger servers 100₁-100₅. The blockchain in FIG. 2 includes data associated with N transactions. Each block of the blockchain 20 (except the genesis block, block 0) includes transaction data, transaction HASH, and block HASH, as well as, optionally, a signature and other data.

An exemplary process of updating a blockchain with new transaction data is shown in FIG. 3. When a new transaction (transaction to be carried out) is initiated, a HASH value, called transaction HASH (see FIG. 3: transaction HASH (N+1)), is first computed based on the new transaction data and the block HASH of the last block in the blockchain. The initiation could be at one of the ledger servers or at one of the computing device (e.g., desktop computer, notebook computer, tablet computer, smart phone, smart watch, smart wearables, etc.) connected to and associated with any of the ledger servers. Then, optionally, the ledger server or the computing device that initiates the new transaction uses its private key, along with the generated transaction HASH value, to compute a digital signature. The digital signature may indicate the ledger server or the computing device connected to and associated with the ledger server submitting the transaction request. In some cases, the ledger server or the computing device connected to and associated with the ledger server may include other optional data in the transaction request, as shown in FIG. 3. Thus, a new transaction request to update the blockchain may include: data of the transaction to be carried out, other optional data, transaction HASH computed based on the last block HASH and the transaction data, and optional digital signature of the ledger server or the computing device connected to and associated with the ledger server submitting the transaction request. The transaction request, once generated, will be provided to ledger servers, optionally with a difficulty requirement, for computing the block HASH for the transaction request.

The ledger servers 100₁-100₅ will then attempt to compute the new block HASH, by solving complicated mathematical problems with cryptographic hash functions that are associated with a block containing the new transaction data. The first one of the ledger servers to successfully determine the new correct block HASH value (see FIG. 3: block HASH (N+1)) verified by 51% of all ledger servers will be awarded, e.g., with a cryptocurrency coin or token. The process is generally known as mining. Afterwards, the verified, determined new correct block HASH value will be appended to the transaction request block. The blockchain ledger in each of the blockchain network will then be updated with the new block containing the new transaction data.

The above mining process is based on “proof of work” method, in which all ledger servers in the blockchain network participate and compete with each other in mining. This “proof of work” method requires significant computation resources (large amounts of computation power and memory, hardware and software) and energy consumption in all of the ledger servers (end-nodes). Also, the ledger servers that lose the computation competition would have all the spent energy and resources wasted. On top of that, the complexity of the mathematical problem increases with the size of the blockchain ledger. As a result, the network slows as its ledger grows.

To address deficiencies in “proof of work” method, “proof of stake” method has been proposed for mining. In “proof of stake”, the influence of the ledger servers is determined based on, e.g., the amount of cryptocurrency held by the server. The more the amount of cryptocurrency, the more influential the ledger server is in the mining process, and is more likely to be elected as the block creator for the new block. Because of the election, the “proof of stake” method consumes less energy than the “proof of work” method. In some implementations of “proof of stake”, as compared with “proof of work”, the mathematical problem to be solved requires less computation power. Nevertheless, the requirement on computation resources (large amounts of computation power and memory, hardware and software) for “proof of stake” can still be quite high. Also, as the election is somewhat biased, the reward would be won mostly by the ledger servers with highest stake.

Both “proof of work” and “proof of stake” can lead to the centralization and accumulation of mining power in specific ledger servers (hence, e.g., into the hands of a few entities), which may be undesirable in some applications.

### SUMMARY OF THE INVENTION

It is an object of the invention to address the above needs, to overcome or substantially ameliorate the above disadvantages or, more generally, to provide a system and method for operating a blockchain network in an energy-efficient, secure, and reliable manner. It is another object of the invention to provide a related blockchain network that is robust, energy-efficient, secure, and scalable. It is yet another object of the invention to provide an energy efficient mining method for operating a blockchain network.

In accordance with a first aspect of the invention, there is provided a method for operating a blockchain network, the blockchain network including a plurality of ledger servers arranged in a first mesh network and collectively maintaining a blockchain ledger, the method comprising: determining that a new transaction data block is to be added to the blockchain ledger; and assigning a mining task (i) to one or more and not all of the ledger servers, or (ii) via one or more of the ledger servers, to one or more electrical IoT devices operably connected with the respective one or more ledger servers. Option (ii) may be via one or more but not all of the ledger servers. The mining task is to compute a HASH value associated with the new transaction for adding the new transaction data block to the blockchain ledger.

In one embodiment of the first aspect, assigning the mining task includes assigning the mining task to one or more and not all of the ledger servers randomly.

In one embodiment of the first aspect, assigning the mining task includes assigning the mining task to one or more electrical IoT devices randomly.

In one embodiment of the first aspect, assigning the mining task includes assigning the mining task to one or more and not all of the ledger servers based on a predetermined mining roster, the predetermining mining roster including a predetermined mining task assignment sequence associated with the ledger servers.

In one embodiment of the first aspect, assigning the mining task includes assigning the mining task to one or more electrical IoT devices based on a predetermined mining roster, the predetermining mining roster including a predetermined mining task assignment sequence associated with the one or more electrical IoT devices.

In one embodiment of the first aspect, assigning the mining task includes assigning the mining task to one or more and not all of the ledger servers based on a respective weighting associated with a computation speed of the respective ledger server. For example, assigning the mining task to one or more and not all of the ledger servers based on the weighting comprises assigning the mining task to one or more of the ledger servers with the highest computation speed(s).

In one embodiment of the first aspect, assigning the mining task includes assigning the mining task to one or more electrical IoT device based on a respective weighting associated with a computation speed of the respective electrical IoT device. For example, assigning the mining task to one or more electrical IoT devices based on the weighting includes assigning the mining task to the one or more electrical IoT devices with the highest computation speed(s).

In one embodiment of the first aspect, assigning the mining task includes assigning the mining task to one or more and not all of the ledger servers based on a respective weighting associated with a mining success rate of the respective ledger server. For example, assigning the mining task to one or more and not all of the ledger servers based on the weighting comprises assigning the mining task to one or more of the ledger servers with a weighting indicating the highest mining success rate(s).

In one embodiment of the first aspect, assigning the mining task includes assigning the mining task to one or more electrical IoT device based on a respective weighting associated with a mining success rate of the respective electrical IoT device. For example, assigning the mining task to one or more electrical IoT devices based on the weighting includes assigning the mining task to the one or more electrical IoT devices with a weighting indicating the highest mining success rate(s).

In one embodiment of the first aspect, the ledger servers are operably connected with a plurality of electrical IoT devices that are arranged in a second mesh network. The plurality of electrical IoT devices includes the one or more electrical IoT devices.

In one embodiment of the first aspect, the first mesh network and the second mesh network are separate mesh networks that are operably connected with each other.

In one embodiment of the first aspect, each of the ledger servers is operably connected with one or more of the electrical IoT devices.

In one embodiment of the first aspect, each of the ledger servers is respectively connected with one or more of the electrical IoT devices in the second mesh network in such a way that each of the electrical IoT device is only directly associated with a single one of the ledger servers.

In one embodiment of the first aspect, assigning the mining task includes assigning the mining task to one or more and not all of the ledger servers based on a respective total number of electrical IoT devices operably connected with the respective ledger server. For example, assigning the mining task to one or more and not all of the ledger servers based on the total number of electrical IoT devices includes assigning the mining task to one or more of the ledger servers operably connected with the largest number(s) of electrical IoT devices.

In one embodiment of the first aspect, assigning the mining task comprises assigning the mining task to one or more and not all of the ledger servers, and the method further includes: sub-assigning, at a ledger server that has been assigned with the mining task, at least part of the mining task to one or more of the electrical IoT devices operably connected with the ledger server.

In one embodiment of the first aspect, the electrical IoT devices do not maintain the blockchain ledger.

In one embodiment of the first aspect, the blockchain network further comprises a plurality of trusted servers arranged in a third mesh network, operably connected with and separate from the first mesh network and the second mesh network, the trusted servers being associated with one or more of the electrical IoT devices. The assignment or sub-assignment of the mining task to the one or more electrical IoT devices may be via one or more of the trusted servers. The trusted servers may be further arranged to maintain the blockchain ledger.

In one embodiment of the first aspect, the assignment of the mining task is performed at an API server operably connected with the ledger servers. The blockchain network may further include the API server. The API server may be arranged in the first mesh network and co-operates with the ledger servers to maintain the blockchain ledger. Or the API server may be connected with the first mesh network (without being part of the first mesh network). The API server may or may not maintain the blockchain ledger.

In one embodiment of the first aspect, the assignment of the mining task is performed at a ledger server controller operably connected with the ledger servers. The ledger server controller may be arranged separately of the ledger servers, or arranged in one of the ledger servers, or arranged distributively across multiple (or all) ledger servers. The ledger server controller may be arranged in the first mesh network.

In one embodiment of the first aspect, determining that a new transaction data block is to be added to the blockchain ledger comprises determining that a transaction request has been initiated. The initiation can be at one of the ledger server, or via one of the ledger server (e.g., by a computing device connected to and associated with the ledger server).

In one embodiment of the first aspect, the method further comprises determining that the mining task has been completed. The method may further include: upon determining that the mining task has been completed, updating the blockchain ledger to include the new transaction data block.

In accordance with a second aspect of the invention, there is provided a system for operating a blockchain network, the blockchain network including a plurality of ledger servers arranged in a first mesh network and collectively maintaining a blockchain ledger, the system comprising one or more processors arranged to: determine that a new transaction data block is to be added to the blockchain ledger; and assign a mining task (i) to one or more and not all of the ledger servers, or (ii) via one or more of the ledger servers, to one or more electrical IoT devices operably connected with the respective one or more ledger servers. Option (ii) may be via one or more but not all of the ledger servers. The mining task is to compute a HASH value associated with the new transaction for adding the new transaction data block to the blockchain ledger.

In one embodiment of the second aspect, the one or more processors are arranged to assign the mining task randomly to one or more and not all of the ledger servers.

In one embodiment of the second aspect, the one or more processors are arranged to assign the mining task randomly to one or more electrical IoT devices.

In one embodiment of the second aspect, the system further includes a memory, operably connected with the one or more processors, storing a predetermining mining roster including a predetermined mining task assignment sequence associated with the ledger servers. And the one or more processors are arranged to assign the mining task to one or more and not all of the ledger servers based on the predetermined mining roster.

In one embodiment of the second aspect, the system further includes a memory, operably connected with the one or more processors, storing a predetermining mining roster including a predetermined mining task assignment sequence associated with a plurality of electrical IoT devices. And the one or more processors are arranged to assign the mining task to one or more of the electrical IoT devices based on the predetermined mining roster.

In one embodiment of the second aspect, the system further includes a memory, operably connected with the one or more processors, storing respective weightings associated with a computation speed of each of the ledger servers. And the one or more processors are arranged to assign the mining task to one or more and not all of the ledger servers based on the respective weightings. For example, the one or more processors are arranged to assign the mining task to one or more of the ledger servers with the highest computation speed(s).

In one embodiment of the second aspect, the system further includes a memory, operably connected with the one or more processors, storing respective weightings associated with a computation speed of each of a plurality of electrical IoT devices. And the one or more processors are arranged to assign the mining task one or more of the electrical IoT devices based on the respective weightings. For example, the one or more processors are arranged to assign the mining task to one or more of the electrical IoT devices with the highest computation speed(s).

In one embodiment of the second aspect, the system further includes a memory, operably connected with the one or more processors, storing respective weightings associated with a mining success rate of each of the ledger servers. The one or more processors are arranged to assign the mining task to one or more and not all of the ledger servers based on the respective weightings. For example, the one or more processors are arranged to assign the mining task to one or more ledger servers with weighting indicating the highest mining success rate(s).

In one embodiment of the second aspect, the system further includes a memory, operably connected with the one or more processors, storing respective weightings associated with a mining success rate of each of a plurality of electrical IoT devices. The one or more processors are arranged to assign the mining task to one or more of the electrical IoT devices based on the respective weightings. For example, the one or more processors are arranged to assign the mining task to one or more of the electrical IoT devices with weighting indicating the highest mining success rate(s).

In one embodiment of the second aspect, the ledger servers are operably connected with a plurality of electrical IoT devices that are arranged in a second mesh network. The plurality of electrical IoT devices includes the one or more electrical IoT devices.

In one embodiment of the second aspect, the first mesh network and the second mesh network are separate mesh networks that are operably connected with each other.

In one embodiment of the second aspect, each of the ledger servers is operably connected with one or more of the electrical IoT devices.

In one embodiment of the second aspect, each of the ledger servers is respectively connected with one or more of the electrical IoT devices in the second mesh network in such a way that each of the electrical IoT device is only directly associated with a single one of the ledger servers.

In one embodiment of the second aspect, the one or more processors are arranged to assign the mining task to one or more of the ledger servers based on a respective total number of electrical IoT devices operably connected with the respective ledger server. For example, the one or more processors are arranged to assign the mining task to one or more of the ledger servers operably connected with the largest number(s) of electrical IoT devices.

In one embodiment of the second aspect, the one or more processors are arranged to assign the mining task to one or more and not all of the ledger servers. The ledger server that has been assigned with the mining task is further arranged to sub-assign at least part of the mining task to one or more of the electrical IoT devices operably connected with that ledger server.

In one embodiment of the second aspect, the electrical IoT devices do not maintain the blockchain ledger.

In one embodiment of the second aspect, the blockchain network further comprises a plurality of trusted servers arranged in a third mesh network, operably connected with the first mesh network and the second mesh network, the trusted servers being associated with one or more of the electrical IoT devices. The assignment or sub-assignment of the mining task to the one or more electrical IoT devices may be via one or more of the trusted servers. The trusted servers may be further arranged to maintain the blockchain ledger. The trusted servers may be further arranged to maintain the blockchain ledger.

In one embodiment of the second aspect, the one or more processors are arranged at an API server operably connected with the ledger servers. The blockchain network may further include the API server. The API server may be arranged in the first mesh network and co-operates with the ledger servers to maintain the blockchain ledger. Or the API server may be connected with the first mesh network (without being part of the first mesh network). The API server may or may not maintain the blockchain ledger.

In one embodiment of the second aspect, the one or more processors are arranged at a ledger server controller operably connected with the ledger servers. The ledger server controller may be arranged separately of the ledger servers, or arranged in one of the ledger servers, or arranged distributively across multiple (or all) ledger servers. The ledger server controller may be arranged in the first mesh network.

In one embodiment of the second aspect, the one or more processors are arranged to determine a new transaction data block is to be added to the blockchain ledger by determining that a transaction request has been initiated. The initiation can be at one of the ledger server, or via one of the ledger server (e.g., by a computing device connected to and associated with the ledger server).

In one embodiment of the second aspect, the one or more processors are further arranged to determine that the mining task has been completed.

In accordance with a third aspect of the invention there is provided a blockchain network comprising: a plurality of ledger servers arranged in a first mesh network and collectively maintaining a blockchain ledger; and one or more processors arranged to: determine that a new transaction data block is to be added to the blockchain ledger; and

assign a mining task (i) to one or more and not all of the ledger servers, or (ii) via one or more of the ledger servers, to one or more electrical IoT devices operably connected with the respective one or more ledger servers. Option (ii) may be via one or more but not all of the ledger servers. The mining task is to compute a HASH value associated with the new transaction for adding the new transaction data block to the blockchain ledger.

In one embodiment of the third aspect, the one or more processors are the one or more processors of the second aspect.

In one embodiment of the third aspect, the blockchain network further comprises a plurality of electrical IoT devices that are arranged in a second mesh network, the ledger servers are operably connected with the plurality of electrical IoT devices.

In one embodiment of the third aspect, the first mesh network and the second mesh network are separate mesh networks that are operably connected with each other.

In one embodiment of the third aspect, each of the ledger servers is operably connected with one or more of the electrical IoT devices.

In one embodiment of the third aspect, each of the ledger servers is respectively connected with one or more of the electrical IoT devices in the second mesh network in such a way that each of the electrical IoT device is only directly associated with one of the ledger servers.

In one embodiment of the third aspect, the electrical IoT devices do not maintain the blockchain ledger.

In one embodiment of the third aspect, the one or more processors are arranged to assign the mining task by: assigning the mining task randomly to one or more and not all of the ledger servers; assigning the mining task randomly to the one or more electrical IoT devices; assigning the mining task to one or more and not all of the ledger servers based on a predetermined mining roster, the predetermining mining roster including a predetermined mining task assignment sequence associated with the ledger servers; assigning the mining task to one or more electrical IoT devices based on a predetermined mining roster, the predetermining mining roster including a predetermined mining task assignment sequence associated with the one or more electrical IoT devices; assigning the mining task to one or more and not all of the ledger servers based on a respective weighting associated with a computation speed of the respective ledger server; assigning the mining task to the one or more electrical IoT device based on a respective weighting associated with a computation speed of the respective electrical IoT device; assigning the mining task to one or more and not all of the ledger servers based on a respective weighting associated with a mining success rate of the respective ledger server; or assigning the mining task to the one or more electrical IoT device based on a respective weighting associated with a mining success rate of the respective electrical IoT device.

In one embodiment of the third aspect, the one or more processors are arranged to assign the mining task by: assigning the mining task to one or more and not all of the ledger servers based on a respective total number of electrical IoT devices operably connected with the respective ledger server. For example, the ledger servers associated with the largest total number(s) of electrical IoT devices may be assigned the mining task.

In one embodiment of the third aspect, a ledger server that has been assigned with the mining task is further arranged to sub-assign at least part of the mining task to one or more of the electrical IoT devices operably connected with that ledger server.

In one embodiment of the third aspect, the blockchain network further includes a plurality of trusted servers arranged in a third mesh network, operably connected with the first mesh network and the second mesh network, the trusted servers being associated with one or more of the electrical IoT devices. The assignment or sub-assignment of the mining task to the one or more electrical IoT devices may be via one or more of the trusted servers. The trusted servers may be further arranged to maintain the blockchain ledger. The trusted servers may be further arranged to maintain the blockchain ledger.

In one embodiment of the third aspect, the one or more processors are arranged at an API server operably connected with the ledger servers.

In one embodiment of the third aspect, the blockchain network further includes the API server. The API server may be arranged in the first mesh network and co-operates with the ledger servers to maintain the blockchain ledger. Or the API server may be connected with the first mesh network (without being part of the first mesh network). The API server may or may not maintain the blockchain ledger.

In one embodiment of the third aspect, the one or more processors are arranged at a ledger server controller operably connected with the ledger servers. The ledger server controller may be arranged separately of the ledger servers, or arranged in one of the ledger servers, or arranged distributively across multiple (or all) ledger servers. The ledger server controller may be arranged in the first mesh network.

In one embodiment of the third aspect, the one or more processors are arranged to determine a new transaction data block is to be added to the blockchain ledger by determining that a transaction request has been initiated. The initiation can be at one of the ledger server, or via one of the ledger server (e.g., by a computing device connected to and associated with the ledger server).

In one embodiment of the third aspect, the one or more processors are further arranged to determine that the mining task has been completed.

### BRIEF DESCRIPTION OF THE DRAWINGS

Embodiments of the invention will now be described, by way of example, with reference to the accompanying drawings in which:

FIG. 1A is a schematic diagram of a basic blockchain network;

FIG. 1B is a schematic diagram of the basic blockchain network of FIG. 1A;

FIG. 2 is a schematic diagram of a blockchain containing information related to N transactions;

FIG. 3 is a schematic diagram illustrating the addition of a new block to the blockchain;

FIG. 4 is a flow chart illustrating a method for operating a blockchain network in one embodiment of the invention.

FIG. 5A is a schematic diagram of a blockchain network in one embodiment of the invention;

FIG. 5B is a schematic diagram of the blockchain network of FIG. 5A;

FIG. 6 is a block diagram of a blockchain network based on that of FIG. 5A in one embodiment of the invention;

FIG. 7 is a block diagram of a blockchain network based on that of FIG. 5A in one embodiment of the invention;

FIG. 8A is a schematic diagram of a blockchain network in one embodiment of the invention;

FIG. 8B is a schematic diagram of the blockchain network of FIG. 8A;

FIG. 9 is a block diagram of a blockchain network based on that of FIG. 8A in one embodiment of the invention;

FIG. 10 is a block diagram of a blockchain network based on that of FIG. 8A in one embodiment of the invention;

FIG. 11 is a block diagram of a blockchain network based on that of FIG. 8A in one embodiment of the invention;

FIG. 12 is a block diagram of a blockchain network based on that of FIG. 8A in one embodiment of the invention;

FIG. 13A is a schematic diagram of a blockchain network in one embodiment of the invention;

FIG. 13B is a schematic diagram of the blockchain network of FIG. 13A;

FIG. 14 is a block diagram of a blockchain network based on that of FIG. 13A in one embodiment of the invention;

FIG. 15 is a functional block diagram of an exemplary information handling device suitable for implementing a ledger server, a trusted server, or an API server in the blockchain network of FIGS. 5A-14; and

FIG. 16 is a functional block diagram of an exemplary electrical IoT device in the blockchain network of FIGS. 8A-14.

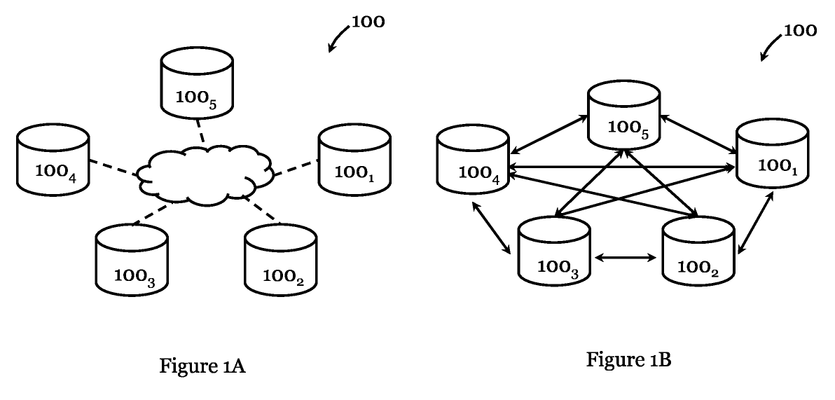

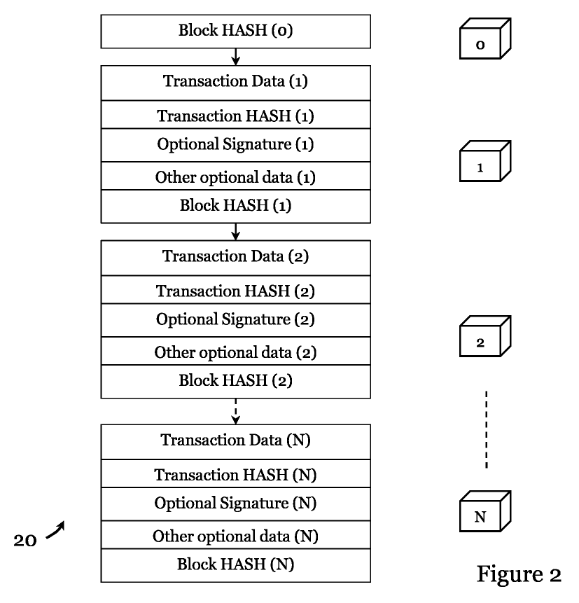

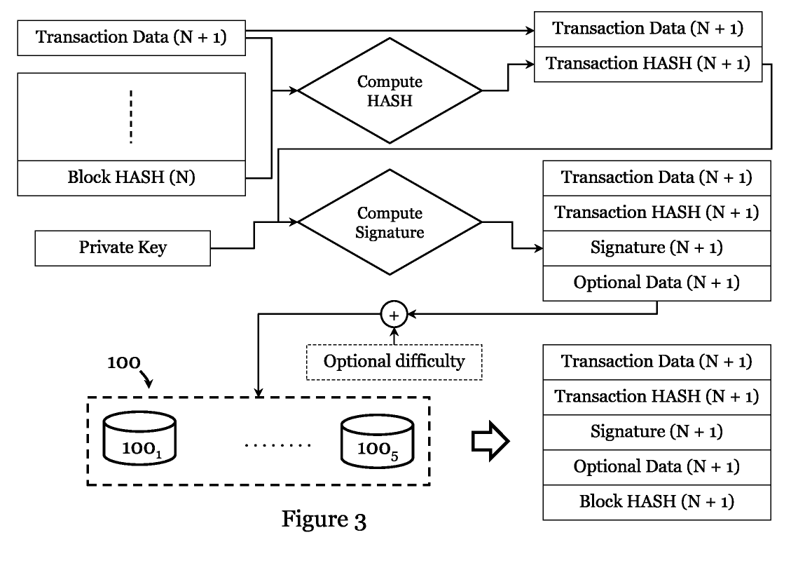

### DETAILED DESCRIPTION OF THE PREFERRED EMBODIMENT

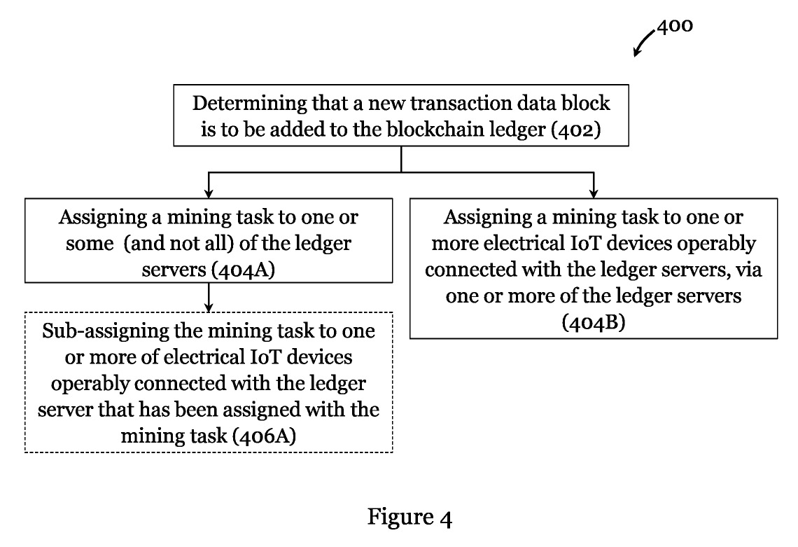

FIG. 4 shows a method 400 for operating a blockchain network in one embodiment of the invention. The method 400 begins when a new transaction request is initiated by one of the ledger servers or by one of the computing device (e.g., desktop computer, notebook computer, tablet computer, smart phone, smart watch, smart wearables, etc.) connected to and associated with any of the ledger servers in the blockchain network. In step 402, it is determined that a new transaction data block is to be added to an existing blockchain ledger stored in each of the ledger servers of the blockchain network.

Upon determining the new transaction request, the method then proceeds to step 404A, in which the mining task, i.e., the task to compute a HASH value associated with the new transaction for adding the new transaction data block to the blockchain ledger (e.g., by solving the mathematical problem with cryptographic hash functions), is assigned to one or more but not all of the ledger servers in the blockchain network.

The assignment of the mining task to one or more but not all of the ledger servers can be random. For example, a selected number (one or more, less than the total number) of random ledger servers is selected for the mining task. In the method, the number of ledger servers being assigned with the mining task is preferably less than 50%, less than 20%, or less than 10% of the total number of ledger servers in the blockchain network.

The assignment of the mining task to one or more but not all of the ledger servers can alternatively be based on pre-determined assignment rules. In one example, the assignment can be based on a predetermined mining roster, the predetermining mining roster including a predetermined mining task assignment sequence associated with the ledger servers. Each mining task assignment sequence may include instructions to assign the mining task to one or more but not all of the ledger servers. In another embodiment, the assignment can be based on a respective weighting associated with a computation speed of the respective ledger server. For example, one or more of the ledger servers with the highest computation speed are assigned with the mining task. In yet another embodiment, the assignment can be based on a respective weighting associated with a mining success rate of the respective ledger server. For example, one or more of the ledger servers with the highest mining success rate are assigned with the mining task. In still yet another embodiment, the assignment can be based on a respective total number of electrical IoT devices operably connected with the respective ledger server. For example, one or more of the ledger servers with the largest number of electrical IoT devices are assigned with the mining task. In the above cases, when more than one ledger server is assigned with the mining task, the ledger servers assigned with the mining task would compete with each other to be the first to compute the HASH value associated with the new transaction. When only one ledger server is assigned with the mining task, then competition does not exist.

Optionally, following step 404A, the method 400 also includes step 406A, in which the or each ledger server that has been assigned with the mining task sub-assigns part or all of the mining task to one or more of electrical IoT devices operably connected with that ledger server. These electrical IoT devices do not maintain the blockchain ledger, but can assist the ledger server in performing the mining task.

In some embodiments, after the determination step 402, the method 400 may proceed to step 404B (instead of step 404A), to assign the mining task to one or more electrical IoT devices operably connected with the ledger servers, via one or more of the ledger servers. Preferably, the assignment of the mining task to the one or more electrical IoT devices operably connected with the ledger servers is via one or more and not all of the ledger servers.

The assignment of the mining task to one or more electrical IoT devices can be random. For example, a selected number (one or more, less than the total number) of random electrical IoT devices is selected for the mining task. In the method, the number of ledger servers being assigned with the mining task is preferably less than 50%, less than 20%, or less than 10% of the total number of electrical IoT devices in the blockchain network.

The assignment of the mining task to the one or more electrical IoT devices can alternatively be based on pre-determined assignment rules. In one example, the assignment can be based on a predetermined mining roster, the predetermining mining roster including a predetermined mining task assignment sequence associated with the electrical IoT devices. Each mining task assignment sequence may include instructions to assign the mining task to the one or more electrical IoT devices. In another embodiment, the assignment can be based on a respective weighting associated with a computation speed of the respective electrical IoT device. For example, one or more of the electrical IoT devices with the highest computation speed are assigned with the mining task. In yet another embodiment, the assignment can be based on a respective weighting associated with a mining success rate of the respective electrical IoT devices. For example, one or more of the electrical IoT devices with the highest mining success rate are assigned with the mining task. In the above cases, when more than one electrical IoT device is assigned with the mining task, the electrical IoT devices assigned with the mining task would compete with each other to be the first to compute the HASH value associated with the new transaction. When only one electrical IoT device is assigned with the mining task, then competition does not exist.

Although not shown, method 400 may further include, after step 406A and step 404B respectively, determining that the mining task has been completed by one of the ledger server being assigned the mining task. The method 400 may then update the blockchain ledger in the blockchain network 500 (in all of the ledger servers, as well as any option devices that hold the blockchain ledger) to include the new transaction data block.

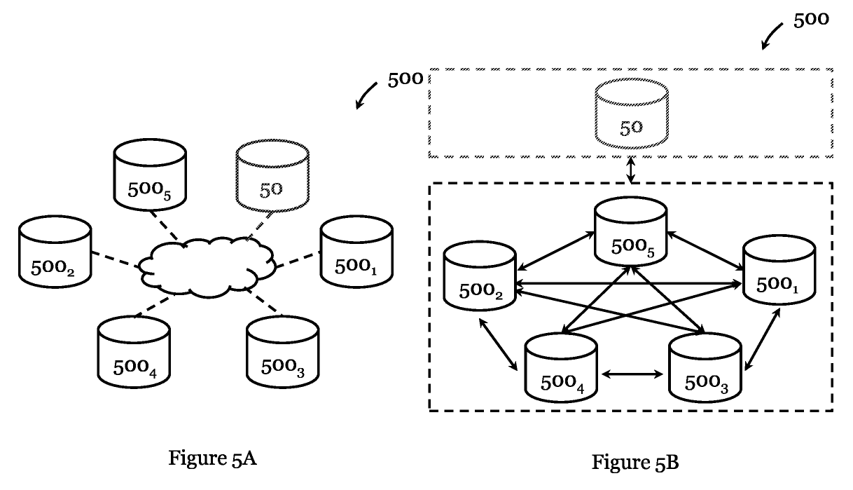

FIGS. 5A and 5B show a schematic diagram of a blockchain network 500 in one embodiment of the invention. The blockchain network 500 includes multiple (five shown, for illustration) information handling devices 500₁-500₅ (“ledger servers”) and an API server 50 operably connected with each other. In this embodiment, for simplicity of illustration, there are five ledger servers 500₁-500₅. These ledger servers 500₁-500₅ are connected to form a mesh network, i.e., each ledger server is connected directly with each and every other ledger server in the mesh network through a wired or wireless communication link (shown as arrows). Each of the ledger servers 500₁-500₅ maintains a respective, identical blockchain that has one or more transaction blocks containing past transaction information. In various embodiments, the number of ledger servers may vary.

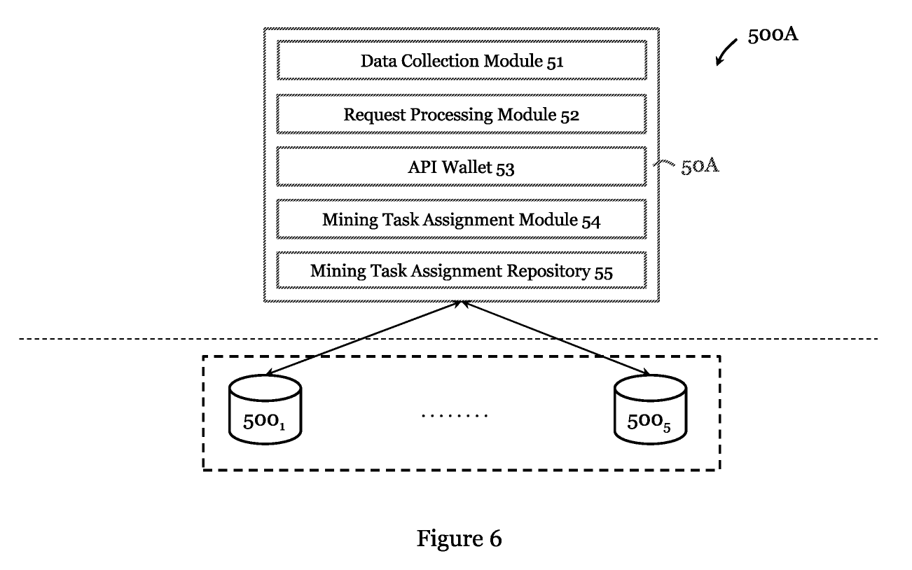

In this embodiment the API server 50 is connected directly with each and every one of the ledger servers 500₁-500₅, essentially also being part of the mesh network. The API server 50 may also hold a copy of the blockchain ledger (but this is not essential). The API server 50 is arranged to, among other things, provide services such as API wallet, data collection, request processing, etc. For example, with reference to FIGS. 6, 7, 9, 12, and 14, the API server includes a data collection module 51 for collecting operation data from the ledger servers 500₁-500₅ and devices (e.g., IoT devices) associated with the ledger servers 500₁-500₅. The API server 50 also includes a request processing module 52 for processing service request transmitted from the ledger servers 500₁-500₅ and devices (e.g., IoT devices) associated with the ledger servers 500₁-500₅ (not shown). The API server maintains an API wallet 53, including the account records of the cryptocurrencies held by the servers and devices in the blockchain network.

FIG. 6 is an implementation of a blockchain network 500A constructed based on the blockchain network 500 of FIGS. 5A and 5B. In the blockchain network 500A in FIG. 6, the API server 50A, based on API server 50, includes the data collection module 51, the request processing module 52, and the API wallet 53 as described above. The API server 50A further includes two functional modules: a mining task assignment module 54 and a mining task assignment repository 55. The mining task assignment module 54 is basically arranged to assign the mining task to any one or more (but not all) of the ledger servers 500₁-500₅ according to the method 400 described with respect to FIG. 4. The mining task assignment repository 55 may store information (e.g., identity, address, etc.) associated with the ledger servers 500₁-500₅ in the blockchain network 500A. In one example, the information may be the computation speed of the ledger servers 500₁-500₅ in the blockchain network 500A, the mining success rate of the ledger servers 500₁-500₅ in the blockchain network 500A, information related to IoT devices (e.g., number of IoT devices) associated with the respective ledger servers 500₁-500₅ in the blockchain network 500A, etc. The information stored in the mining task assignment repository 55 may be used by the mining task assignment module 54 to determine which of the ledger server(s) 500₁-500₅ the mining task should be assigned to.

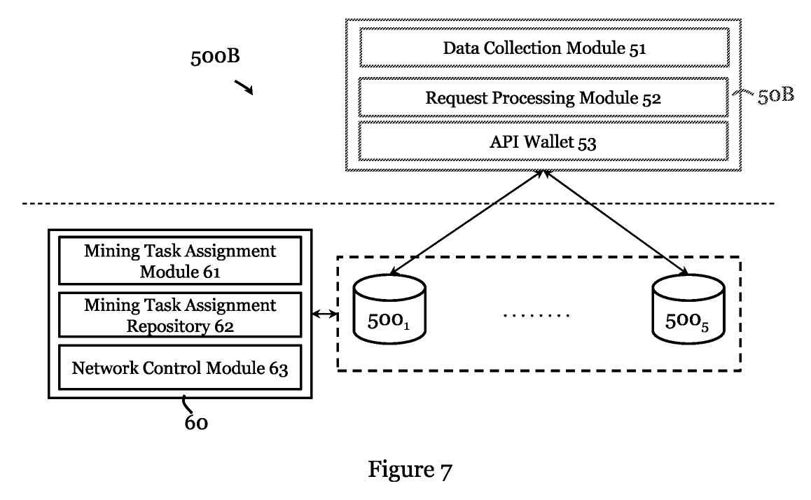

FIG. 7 is an implementation of a blockchain network 500B constructed based on the blockchain network 500 of FIGS. 5A and 5B. In the blockchain network 500B in FIG. 7, the API server 50B, based on API server 50, includes the data collection module 51, the request processing module 52, and the API wallet 53 as described above. However, the API server 50B does not include a mining task assignment module and a mining task assignment repository. Instead, in this embodiment, the blockchain network further includes a ledger server controller 60. The ledger server controller 60 may be arranged in a server separate from the ledger servers 500₁-500₅. Alternatively, the ledger server controller 60 may be arranged in one of the ledger servers 500₁-500₅, or arranged distributively across multiple (or all) ledger servers 500₁-500₅. The ledger server controller 60 includes a mining task assignment module 61 and a mining task assignment repository 62, that serve the same function as the mining task assignment module 54 and a mining task assignment repository 55 in the API server 50A of FIG. 6. In brief, the mining task assignment module 61 is to assign the mining task to any one or more (but not all) of the ledger servers 500₁-500₅ according to the method 400 described with respect to FIG. 4, and the mining task assignment repository 62 is to store information (e.g., identity, address, etc.) associated with the ledger servers 500₁-500₅ in the blockchain network 500A to assist with the assignment. The ledger server controller 60 also includes a network control module 63 for controlling data flow among the ledger servers 500₁-500₅.

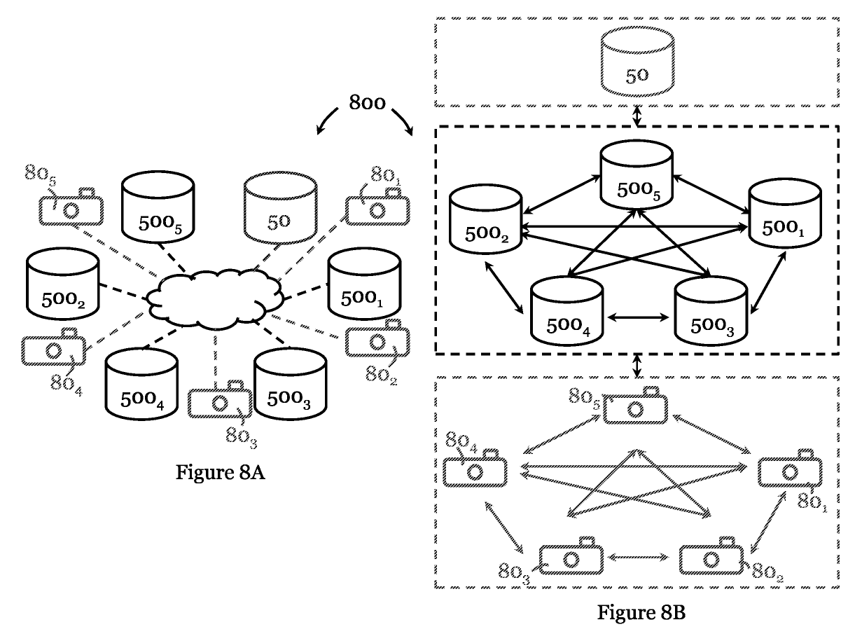

FIGS. 8A and 8B show a schematic diagram of a blockchain network 800 in one embodiment of the invention. The blockchain network 800 is similar to the blockchain network 500 as they both include multiple ledger servers 500₁-500₅ and API server 50 operably connected with each other. The structure and function of the API server 50 and the information handling devices 500₁-500₅ will not be repeated here. The blockchain network 800 is different from the blockchain network 500 in that it further includes multiple (five shown, for illustration) electrical IoT devices 80₁-80₅ operably connected with the ledger servers 500₁-500₅. As shown in FIG. 8B, electrical IoT devices 80₁-80₅ are arranged in a mesh network such that each IoT device is connected with each and every one of the other IoT devices. The electrical IoT devices 80₁-80₅ do not maintain the blockchain ledger. In this embodiment, the mesh network of the ledger servers 500₁-500₅ and the mesh network of the IoT devices 80₁-80₅ are separate mesh networks operably connected with each other. In other words, the IoT devices 80₁-80₅ and the ledger servers 500₁-500₅ do not join to form a single mesh network. In various embodiments, the number of the IoT devices and the ledger servers may vary. Also, each of the ledger servers may be associated with respective IoT devices.

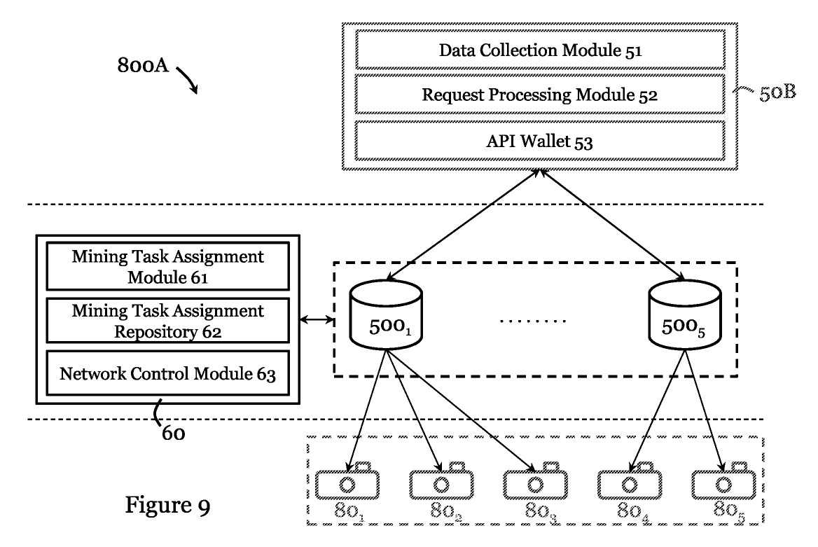

FIG. 9 is an implementation of a blockchain network 800A constructed based on the blockchain network 800 of FIGS. 8A and 8B. This network 800A is the same as the network 500B in FIG. 7, except that the ledger servers 500₁-500₅ are associated with the IoT devices 80₁-80₅. In this example, the ledger server 500₁ is associated with the IoT devices 80₁-80₃; the ledger server 500₅ is associated with the IoT devices 80₄-80₅.

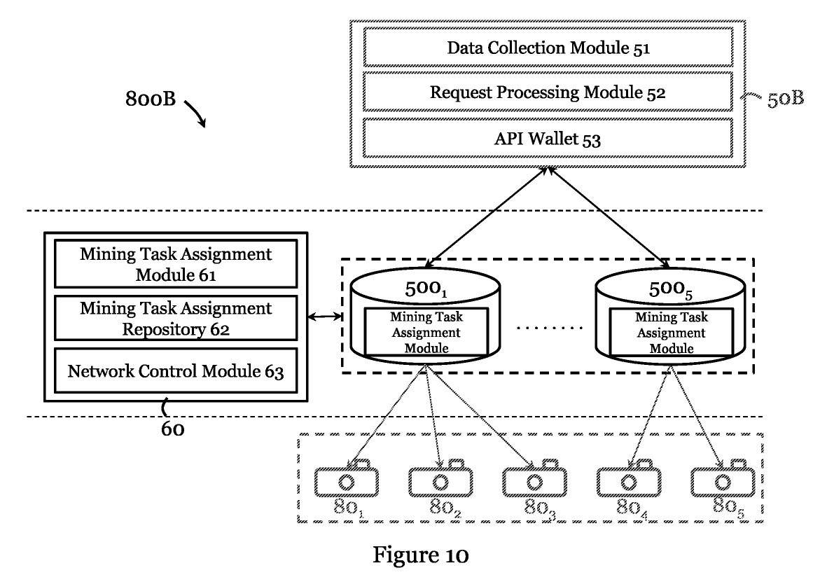

FIG. 10 is an implementation of a blockchain network 800B constructed based on the blockchain network 800 of FIGS. 8A and 8B. This network 800B is the same as the network 800A in FIG. 9, except that the ledger servers 500₁, 500₅ include a further mining task assignment module for further assigning, or sub-assigning, part or all of the mining task (assuming that the ledger server has been assigned by the controller 60) to the corresponding IoT devices associated therewith, similar to step 406 in method 400 of FIG. 4. The sub-assignment may be similar to the assignment described with respect to step 404A in FIG. 4, either random or based on predetermined rules. In one example, the predetermined rule may be to assign to the IoT device with the highest computation speed, highest success rate, a particular type of IoT device, etc.

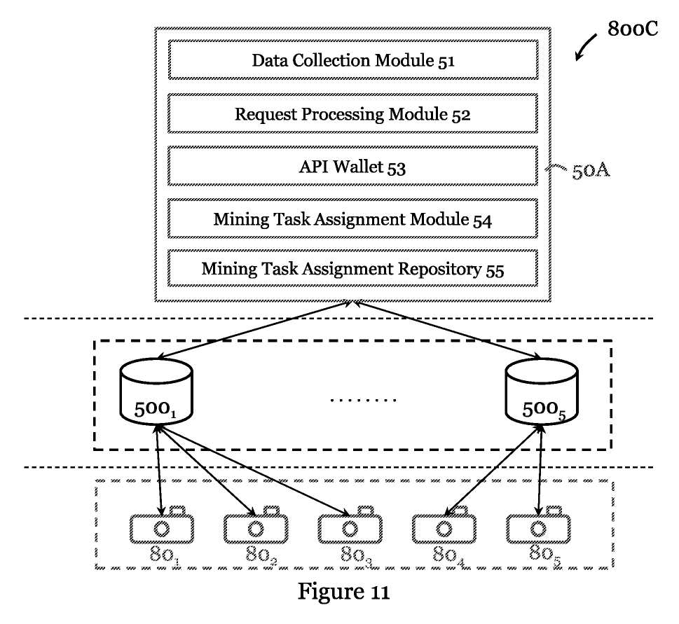

FIG. 11 is an implementation of a blockchain network 800C constructed based on the blockchain network 800 of FIGS. 8A and 8B. This network 800C is the same as the network 500A in FIG. 6, except that the ledger servers 500₁-500₅ are associated with the IoT devices 80₁-80₅. In this example, the ledger server 500₁ is associated with the IoT devices 80₁-80₃; the ledger server 500₅ is associated with the IoT devices 80₄-80₅.

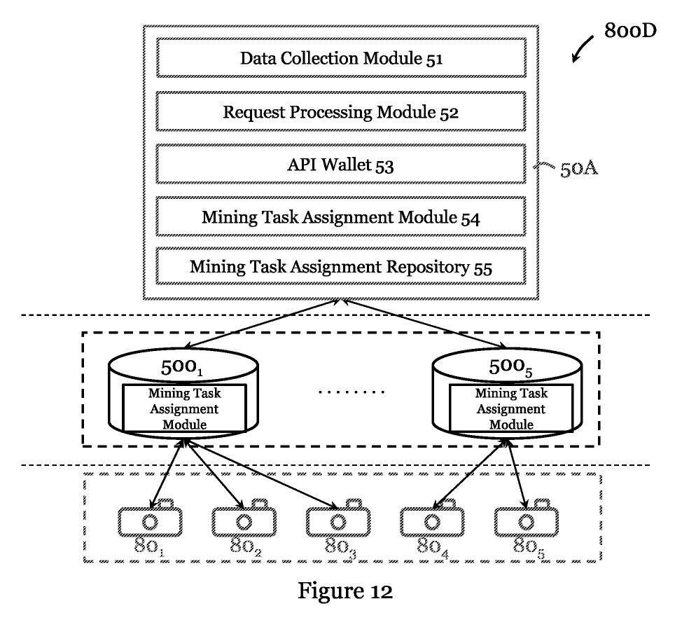

FIG. 12 is an implementation of a blockchain network 800D constructed based on the blockchain network 800 of FIGS. 8A and 8B. This network 800D is the same as the network 800C in FIG. 11, except that the ledger servers 500₁, 500₅ include a further mining task assignment module for further assigning, or sub-assigning, part or all of the mining task (assuming that the ledger server has been assigned by the controller 60) to the corresponding IoT devices associated therewith, similar to step 406 in method 400 of FIG. 4. The sub-assignment may be similar to the assignment described with respect to step 404A in FIG. 4, either random or based on predetermined rules. In one example, the predetermined rule may be to assign to the IoT device with the highest computation speed, highest success rate, a particular type of IoT device, etc.

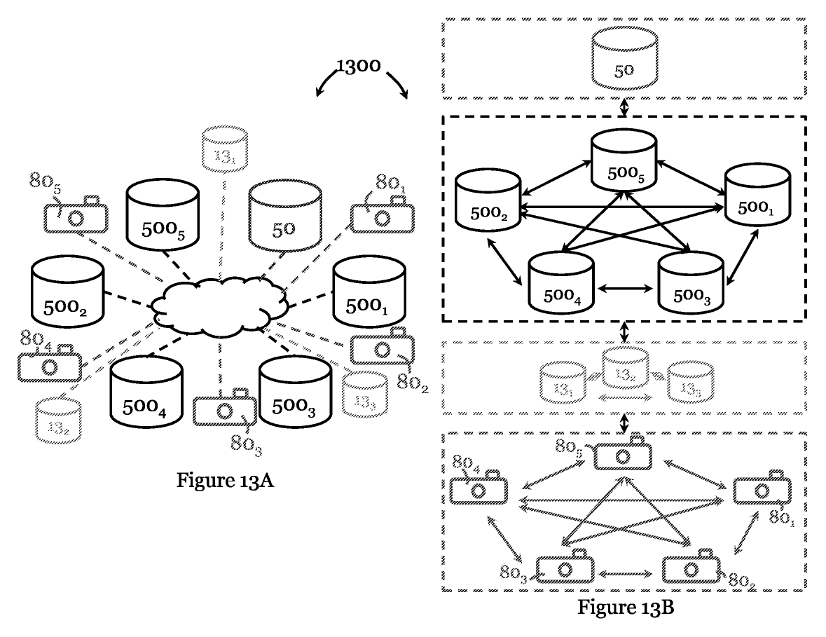

FIGS. 13A and 13B show a schematic diagram of a blockchain network 1300 in one embodiment of the invention. The blockchain network 1300 is similar to the blockchain network 800 as they both include multiple ledger servers 500₁-500₅, API server 50, and multiple IoT devices 80₁-80₅ operably connected with each other. The structure and function of the API server 50, the information handling devices 500₁-500₅, and the IoT devices 80₁-80₅ will not be repeated here. The blockchain network 1300 is different from the blockchain network 800 in that it further includes multiple (three shown, for illustration) trusted servers 13₁-13₃ operably connected with each other in a mesh network. As shown in FIG. 13B, trusted servers 13₁-13₃ are arranged in a mesh network such that each trusted server is connected with each and every one of the other trusted servers. The trusted servers 13₁-13₃ may also maintain the blockchain ledger, like to ledger servers 500₁-500₅. In this embodiment, the mesh network of the trusted servers 13₁-13₃, the mesh network of the ledger servers 500₁-500₅, and the mesh network of the IoT devices 80₁-80₅ are separate mesh networks operably connected with each other. In other words, the IoT devices 80₁-80₅, the ledger servers 500₁-500₅, and trusted servers 13₁-13₃, do not join to form a single mesh network. In various embodiments, the number of the IoT devices, the trusted servers, and the ledger servers may vary. Also, each of the ledger servers may be associated with one or more trusted servers, and the trusted servers may in turn be associated with one or more IoT devices. In this embodiment, a trusted server can be associated with two or more ledger servers; an IoT device can be associated with one or more trusted servers.

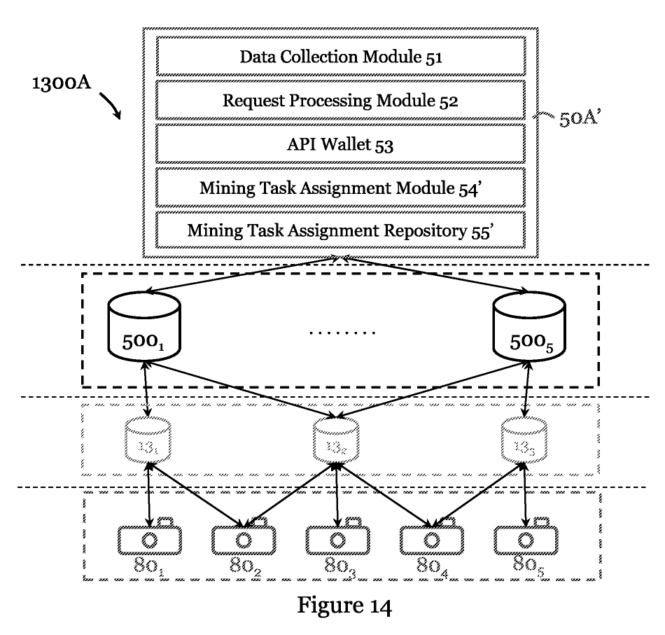

FIG. 14 is an implementation of a blockchain network 1300A constructed based on the blockchain network 1300 of FIGS. 13A and 13B. This network 1300A is the same as the network 800C in FIG. 11, except with the addition of the trusted server mesh network between the ledger servers and the IoT devices, and the slight modification of the API server 50A′. In this example, the ledger server 500₁ is associated with the trusted servers 13₁, 13₂; the ledger server 500₅ is associated with the trusted servers 13₂, 13₃. The trusted server 13₁ is associated with IoT devices 80₁-80₂; the trusted server 13₂ is associated with IoT devices 80₂-80₄; the trusted server 13₃ is associated with IoT devices 80₄-80₅. The API server 50A′ is similar to the API server 50A, except for the mining task assignment module 54′ and the mining task assignment repository 55′.

The assignment of the mining task is from the API server 50A′ to one or more of the IoT devices 80₁-80₅ via the corresponding ledger server(s) 500₁-500₅ and trusted server(s) 13₁-13₃, using the method 400 (via step 404B) described above. In this embodiment of FIG. 14, the mining task assignment module 54′ is arranged to assign the mining task to any one or more of the electrical IoT devices 80₁-80₅, via the ledger servers 500₁-500₅ and the trusted server(s) 13₁-13₃, according to the method 400 (via step 404B) described with respect to FIG. 4. The mining task assignment repository 55′ may store information (e.g., identity, address, etc.) associated with the IoT devices 80₁-80₅ in the blockchain network 500A. In one example, the information may be the computation speed of the electrical IoT devices 80₁-80₅ in the blockchain network 500A, the mining success rate of the electrical IoT devices 80₁-80₅ in the blockchain network 500A, information related to the trusted server associated with the respective IoT devices 80₁-80₅ in the blockchain network 500A, etc. The information stored in the mining task assignment repository 55′ may be used by the mining task assignment module 54′ to determine which of the electrical IoT device(s) 80₁-80₅ the mining task should be assigned to.

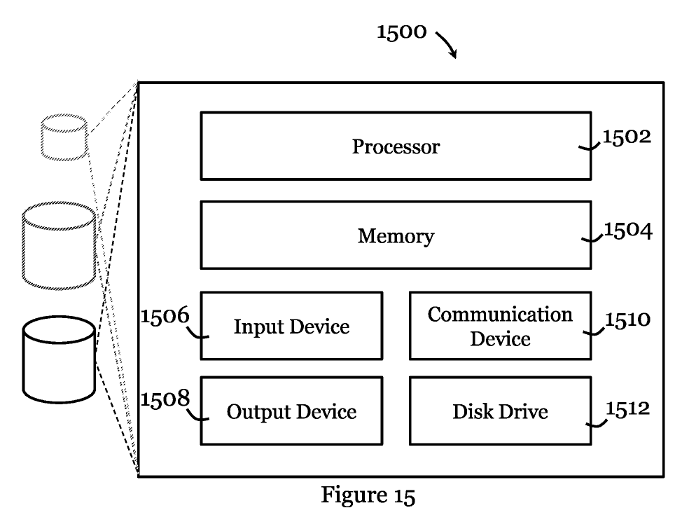

Referring to FIG. 15, there is shown a schematic diagram of an exemplary information handling system 1500 that can be used as a server (e.g., the ledger server 500₁-500₅, the trusted server 13₁-13₃, the API server 50A, 50B, etc.) or a computing device (the computing device that is connected to and associated with the ledger server 500₁-500₅ to initiate the new transaction request) in one embodiment of the invention. The information handling system 1500 provides the structure or hardware for implementing various functional modules in the ledger server, the trusted server, the API server, etc. The information handling system 1500 may have different configurations, and it generally comprises suitable components necessary to receive, store, and execute appropriate computer instructions, commands, or codes. The main components of the information handling system 1500 are a processor 1502 and a memory unit 1504. The processor 1502 may be formed by one or more CPU, MCU, controllers, logic circuits, Raspberry Pi chip, etc. The memory unit 1504 may include one or more volatile memory unit (such as RAM, DRAM, SRAM), one or more non-volatile unit (such as ROM, PROM, EPROM, EEPROM, FRAM, MRAM, FLASH, SSD, NAND, and NVDIMM), or any of their combinations. Preferably, the information handling system 1500 further includes one or more input devices 1506 such as a keyboard, a mouse, a stylus, an image scanner, a microphone, a tactile input device (e.g., touch sensitive screen), and an image/video input device (e.g., camera). The information handling system 1500 may further include one or more output devices 1508 such as one or more displays (e.g., monitor), speakers, disk drives, headphones, earphones, printers, 3D printers, etc. The display may include a LCD display, a LED/OLED display, or any other suitable display that may or may not be touch sensitive. The information handling system 1500 may further include one or more disk drives 1512 which may encompass solid state drives, hard disk drives, optical drives, flash drives, and/or magnetic tape drives. A suitable operating system may be installed in the information handling system 1500, e.g., on the disk drive 1512 or in the memory unit 1504. The memory unit 1504 and the disk drive 1512 may be operated by the processor 1502. The information handling system 1500 also preferably includes a communication device 1510 for establishing one or more communication links (not shown) with one or more other computing devices such as servers, personal computers, terminals, tablets, phones, or other wireless or handheld computing devices. The communication device 1510 may be a modem, a Network Interface Card (NIC), an integrated network interface, a radio frequency transceiver, an optical port, an infrared port, a USB connection, or other wired or wireless communication interfaces. The communication links may be wired or wireless for communicating commands, instructions, information and/or data. Preferably, the processor 1502, the memory unit 1504, and optionally the input devices 1506, the output devices 1508, the communication device 1510 and the disk drives 1512 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the information handling system 1500 shown in FIG. 15 is merely exemplary and different information handling systems 1500 with different configurations may be applicable in the invention.

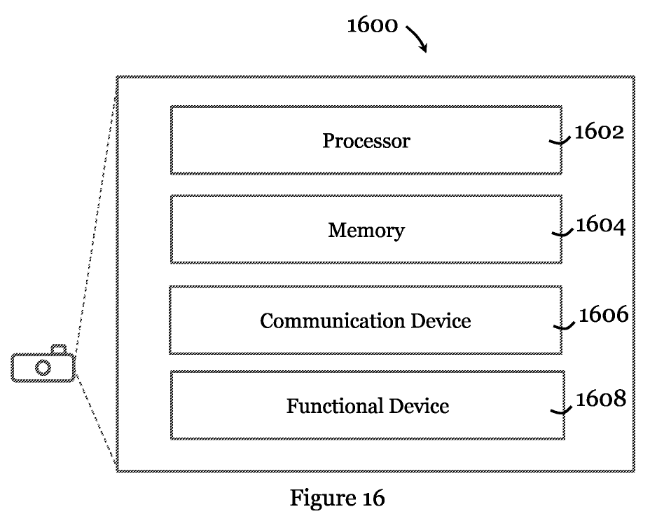

Referring to FIG. 16, there is shown a schematic diagram of an exemplary IoT device 1600 in one embodiment of the invention. The IoT device 1600 may have different configurations, and it generally comprises suitable components necessary to receive, store, and execute appropriate computer instructions, commands, or codes. The main components of the IoT device 1600 are a processor 1602 and a memory unit 1604. The processor 1602 may be formed by one or more CPU, MCU, controllers, logic circuits, Raspberry Pi chip, etc. The memory unit 1604 may include one or more volatile memory unit (such as RAM, DRAM, SRAM), one or more non-volatile unit (such as ROM, PROM, EPROM, EEPROM, FRAM, MRAM, FLASH, SSD, NAND, and NVDIMM), or any of their combinations. Preferably, the IoT device 1600 further includes a communication device 1606 for establishing one or more communication links (not shown) with one or more other computing devices such as servers, personal computers, terminals, tablets, phones, or other wireless or handheld computing devices. The communication device 1606 may be a modem, a Network Interface Card (NIC), an integrated network interface, a radio frequency transceiver, an optical port, an infrared port, a USB connection, or other wired or wireless communication interfaces. The communication links may be wired or wireless for communicating commands, instructions, information and/or data. The IoT device 1600 may further include a functional device 1608 to perform a principal function. For example, the IoT device 1600 may be a camera, and the functional device 1608 is a lens assembly for capturing an image. For example, the IoT device 1600 may be a fridge, and the functional device 1608 is a coolant circulation assembly for circulating coolant. Preferably, the processor 1602, the memory unit 1604, and optionally the communication device 1606 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the IoT device 1600 shown in FIG. 16 is merely exemplary and different IoT device 1600 with different functions and configurations may be applicable in the invention.

The above embodiments of the invention are advantageous in that only one or a limited number of ledger servers or electrical IoT devices in the blockchain network are assigned to perform mining, i.e., to carry out the block HASH computation. As a result, the amount of computation energy (or electric energy) wasted is substantially reduced.

Some embodiments of the above invention include IoT devices that can participate in the mining process. These embodiments are advantageous as they may help to promote the adoption of IoT devices in the blockchain networks. In one example, such device mesh networks are mesh networks connecting household appliance (white goods) or office equipment (printer server, photocopier, network router, etc.). If such devices can be connected to ledger servers in the blockchain network and be awarded by participating in mining, the adoption of IoT devices can be made easier. Also, the high memory and storage requirement for traditional blockchain mining do not apply to such IoT device acting as mining devices. The actual assignment of mining task can be done by the mining assignment block in the ledger server mesh network controller or API server via selected ledger server(s), or, alternatively or additionally, by further assignment down the network layer with another mining assignment block in ledger servers.

The above embodiments of the invention can run on existing IoT devices without the need to change any hardware. Existing IoT device users can readily connect their devices to the blockchain network. The usage data of these devices can be obtained by the network, e.g., via the API server. Some embodiments of the invention with end-nodes and trusted-nodes separated enable IoT devices to be easily connected to the blockchain system. The above embodiments of the invention also support instant transactions substantially independent of size of the blockchain ledger (e.g., even if the blockchain ledger expands in size exponentially as the network grows). The invention provides a solution for integrating blockchain with IoT devices can seamlessly work together.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system”, “computing device”, or the like are used, these terms are intended to include any appropriate arrangement of computer or information processing hardware capable of implementing the function described.

It will be appreciated by persons skilled in the art that numerous variations and/or modifications may be made to the invention as shown in the specific embodiments without departing from the spirit or scope of the invention as broadly described. The described embodiments of the invention should therefore be considered in all respects as illustrative, not restrictive. It should also be noted that the above description is made to illustrate the invention specific to blockchain networks, and is not intended to be an exhaustive and complete basic review of blockchain systems. Blockchain system elements (structures, modules, etc.) that are directly related to the invention are not described for clarity and simplicity.

For example, the number of ledger servers in the blockchain network can be any number. The number of IoT devices can also be any number. The number of trusted servers can also be any number. Each of the IoT devices can be associated with only one ledger server, or may be associated with two or more ledger servers. The IoT devices can take any form and type and can perform different functions. The IoT devices can be any devices with communication device/module/elements to communicate with one or more ledger servers in the blockchain network. Exemplary IoT devices include household appliance (e.g., white goods), office equipment (printer servers, photocopiers, network routers, etc.), and various electronic devices (clock, radio, camera, etc.). Any number of server (e.g., trusted server) mesh network may be arranged between and operably connected with the ledger server mesh network and the IoT devices mesh network, to enhance scalability. The API server may or may not hold a copy of the blockchain ledger. The API server may directly connect to only one or some (and not necessarily all) of the ledger servers. The ledger server controller may or may not hold a copy of the blockchain ledger. The predetermined rules for assigning the mining task may be implemented in a combined manner. For example, the mining success rate and the computation power of the ledger servers and/or the electrical IoT devices can both be taken into account in determining which ledger server(s) and/or the electrical IoT devices should be assigned the mining task. As an alternative, any of the electronic IoT devices may be replaced with a computing device (e.g., desktop computer, notebook computer, tablet computer, smart phone, smart watch, smart wearables, etc.) that can communicate directly or indirectly with the ledger server(s). The computing device may have the construction of the information handling system 1500 in FIG. 15.

1. A method for operating a blockchain network including a plurality of ledger servers arranged in a first mesh network and collectively maintaining a blockchain ledger, the method comprising:
determining that a new transaction data block is to be added to the blockchain ledger; and
assigning a mining task:
(i) to one or more and not all of the ledger servers; or
(ii), via one or more of the ledger servers, to one or more electrical IoT devices operably connected with the respective one or more ledger servers, wherein the mining task is to compute a HASH value associated with the new transaction for adding the new transaction data block to the blockchain ledger.

2. The method of claim 1, wherein assigning the mining task comprises assigning the mining task to one or more and not all of the ledger servers randomly.

3. The method of claim 1, wherein assigning the mining task comprises assigning the mining task to one or more electrical IoT devices randomly.

4. The method of claim 1, wherein assigning the mining task comprises assigning the mining task to one or more and not all of the ledger servers based on a predetermined mining roster, the predetermined mining roster including a predetermined mining task assignment sequence associated with the ledger servers.

5. The method of claim 1, wherein assigning the mining task comprises assigning the mining task to one or more electrical IoT devices based on a predetermined mining roster, the predetermined mining roster including a predetermined mining task assignment sequence associated with the one or more electrical IoT devices.

6. The method of claim 1, wherein assigning the mining task comprises assigning the mining task to one or more and not all of the ledger servers based on a respective weighting associated with computation speed of the respective ledger server.

7. The method of claim 1, wherein assigning the mining task comprises assigning the mining task to one or more electrical IoT device based on a respective weighting associated with computation speed of the respective electrical IoT device.

8. The method of claim 1, wherein assigning the mining task comprises assigning the mining task to one or more and not all of the ledger servers based on a respective weighting associated with mining success rate of the respective ledger server.

9. The method of claim 1, wherein assigning the mining task comprises assigning the mining task to one or more electrical IoT device based on a respective weighting associated with mining success rate of the respective electrical IoT device.

10. The method of claim 1, wherein the ledger servers are operably connected with a plurality of electrical IoT devices that are arranged in a second mesh network, and the first mesh network and the second mesh network are separate mesh networks operably connected with each other, wherein the plurality of electrical IoT devices include the one or more electrical IoT devices.

11. The method of claim 10, wherein each of the ledger servers is operably connected with one or more of the electrical IoT devices.

12. The method of claim 10, wherein each of the ledger servers is respectively connected with one or more of the electrical IoT devices in the second mesh network in such a way that each of the electrical IoT device is only directly associated with a single one of the ledger servers.

13. The method of claim 10, wherein assigning the mining task comprises assigning the mining task to one or more and not all of the ledger servers based on a respective total number of electrical IoT devices operably connected with the respective ledger server.

14. The method of claim 10, wherein
assigning the mining task comprises assigning the mining task to one or more and not all of the ledger servers, and
sub-assigning, at a ledger server that has been assigned with the mining task, at least part of the mining task, to one or more of the electrical IoT devices operably connected with the ledger server.

15. The method of claim 1, wherein the electrical IoT devices do not maintain the blockchain ledger.

16. The method of claim 10, wherein
the blockchain network further comprises a plurality of trusted servers arranged in a third mesh network, operably connected with and separate from the first mesh network and the second mesh network, the trusted servers being associated with one or more of the electrical IoT devices, and
assigning the mining task to the one or more electrical IoT devices is via one or more of the trusted servers.

17. The method of claim 16, wherein the trusted servers are arranged to maintain the blockchain ledger.

18. The method of claim 1, wherein assigning of the mining task is performed at an API server operably connected with the ledger servers.

19. The method of claim 18, wherein the blockchain network further includes the API server.

20. The method of claim 1, wherein assigning of the mining task is performed at a ledger server controller operably connected with the ledger servers.

21. The method of claim 1, wherein determining that a new transaction data block is to be added to the blockchain ledger comprises determining that a transaction request has been initiated.

22. A system for operating a blockchain network, the blockchain network including a plurality of ledger servers arranged in a first mesh network and collectively maintaining a blockchain ledger, and a plurality of electrical IoT devices operably connected with respective ledger servers, the system comprising:
one or more processors arranged to:
determine that a new transaction data block is to be added to the blockchain ledger; and
assign a mining task
(i) to one or more and not all of the ledger servers, or
(ii), via one or more of the ledger servers, to one or more of the electrical IoT devices, wherein the mining task is to compute a HASH value associated with the new transaction for adding the new transaction data block to the blockchain ledger.

23. The system of claim 22, wherein the one or more processors are arranged to assign the mining task randomly.

24. The system of claim 22, further including a memory, operably connected with the one or more processors, storing a predetermined mining roster including a predetermined mining task assignment sequence, wherein the processor is arranged to assign the mining task based on the predetermined mining roster.

25. The system of claim 22, further including a memory, operably connected with the one or more processors, storing respective weightings associated with computation speed of each of the ledger servers, wherein the one or more processors are arranged to assign the mining task to one or more and not all of the ledger servers based on the respective weightings.

26. The system of claim 22, further including a memory, operably connected with the one or more processors, storing respective weightings associated with computation speed of each of the electrical IoT devices, wherein the one or more processors are arranged to assign the mining task to one or more of the electrical IoT devices based on the respective weightings.

27. The system of claim 22, further including a memory, operably connected with the one or more processors, storing respective weightings associated with a mining success rate of each of the ledger servers, and wherein the one or more processors are arranged to assign the mining task to one or more and not all of the ledger servers based on the respective weightings.

28. The system of claim 22, further including a memory, operably connected with the one or more processors, storing respective weightings associated with mining success rate of each of the electrical IoT devices, wherein the one or more processors are arranged to assign the mining task to one or more of the electrical IoT devices based on the respective weightings.

29. The system of claim 22, wherein the ledger servers are operably connected with the plurality of electrical IoT devices, which are arranged in a second mesh network, wherein
the first mesh network and the second mesh network are separate mesh networks operably connected with each other, and
the plurality of electrical IoT devices includes the one or more electrical IoT devices.

30. The system of claim 29, wherein the one or more processors are arranged to assign the mining task to one or more and not all of the ledger servers based on a respective total number of electrical IoT devices operably connected with the respective ledger server.

31. The system of claim 22, wherein the ledger server that has been assigned with the mining task by the one or more processors is arranged to sub-assign at least part of the mining task to one or more of the electrical IoT devices operably connected with the corresponding ledger server.
